(19) United States
(12) Patent Application Publication
(10) Pub. No.: US 2003/0031331 A1
(43) Pub. Date: Feb. 13, 2003

(54) Bending wave acoustic panel

(75) Inventors: Neil Harris, Cambridge (GB); Elena Prokofieva, Bradford (GB); Kirill Horoshenkov, Burley in Wharfedale (GB)

Correspondence Address: FOLEY AND LARDNER, SUITE 500, 3000 K STREET NW, WASHINGTON, DC, 20007, US

(73) Assignee: NEW TRANSDUCERS LIMITED

(21) Appl. No.: 10/141,783

(22) Filed: May 10, 2002

Related U.S. Application Data
(60) Provisional application No. 60/309,873, filed on Aug. 6, 2001.

(30) Foreign Application Priority Data
Jul. 31, 2001 (GB) 0118586.7
Aug. 6, 2001 (GB) 0119138.6

(51) Int. Cl. H04R 25/00

(52) U.S. Cl. 381/152

(57) ABSTRACT

A bending wave panel loudspeaker with a bending wave acoustic panel that is capable of supporting bending wave vibration. The panel has a front face and a rear face, and a transducer mounted on the panel to excite bending wave vibration in the panel in response to an electrical signal applied to the transducer so that sound energy is radiated from both the front and the rear faces of the panel. An acoustically porous resistive structure is mounted proximate to one face of the panel to resistively impede sound energy radiated from that one face.

### CROSS-REFERENCE TO RELATED APPLICATIONS

This application claims the benefit of U.S. provisional application No. 60/309,873, filed Aug. 6, 2001.

### BACKGROUND

The invention relates to bending wave acoustic panels, e.g. panel loudspeakers, and more particularly to resonant acoustic panels, e.g. of the general kind described in commonly owned U.S. Pat. No. 6,332,029 (which is incorporated herein by reference).

It is known that the degree of diffusivity of a bending wave acoustic panel, e.g. of the distributed mode variety, tends to diminish towards the lower frequency range, i.e. below 1 kHz. The very lowest modes of vibration, in particular the whole body mode, are essentially coherent and thus suffer from two well known acoustic effects. In free space there is cancellation of lower frequency sound energy between front and back radiation surfaces which results in an approximation to dipole behaviour at these frequencies. Furthermore when the panel is placed in proximity to a rear plane, which may be near or fully coplanar therewith, energy is reflected by the plane. The reflected energy selectively cancels or interferes with the output resulting in response irregularities.

These problems have been addressed in certain respects by a number of proposals, in the following patent specifications, namely U.S. Pat. No. 6,332,029, U.S. Pat. No. 6,215,881, U.S. Pat. No. 6,327,369, GB2246684 and GB2367706. For example, in one proposal a soft plastic absorbing foam is mounted between the panel and the plane. The foam absorbs some of the sound energy from the face of the panel adjacent the plane and hence the interference from reflected energy is reduced. Such an absorber can be helpful at higher frequencies but does not address the low frequency radiation from the free edges of the panel.

In another proposal a soft plastic foam absorber, of the kind which is typically found in a speaker enclosure, is integrated with an edge suspension for a bending wave panel. However, the effectiveness of such absorbers at absorbing low frequency radiation decreases in proportion to their thickness. For example an absorber formed from loudspeaker grade polyurethane foam plastics and having a thickness of 25 mm becomes effective, with only moderately useful action, above 1 kHz. Below this frequency, its effectiveness progressively diminishes. For a larger panel with a low frequency range extending down to 100 Hz, an absorber made from the same foam would only be effective if it had a thickness of 2,500 mm. Clearly, such an absorber is impractical and thus does not address the problems associated with low frequency radiation.

### SUMMARY OF THE INVENTION

According to the invention, there is provided a bending wave panel loudspeaker comprising a bending wave acoustic panel that is capable of supporting bending wave vibration, the panel having a front face and a rear face, a transducer mounted on the panel to excite bending wave vibration in the panel so that sound energy is radiated from both the front and the rear faces of the panel, and a resistive structure which is acoustically porous and which is mounted proximate to one face of the panel to resistively impede sound energy which is radiated from the face.

The resistive structure may be plate-like and may be coplanar or near coplanar with the panel. The resistive structure may be mounted so as to define an air gap between the panel and the resistive structure. The air gap is preferably small enough to ensure useful resistive coupling between the sound energy radiated from the panel and the resistive structure.

In contrast to the known solutions which use an absorber of conventional form, the resistive structure is designed to resistively impede the progress of sound energy rather than absorb incident energy. The resistive structure may be designed to impede all sound energy, in particular the lowest frequencies of operation of the loudspeaker. The resistive structure may provide a path through which waves having longer wavelengths, i.e. lower frequencies, pass with significant attenuation due to the non-reactive porosity of the resistance. The invention thus uses a pure or nearly pure acoustic resistance rather than an absorber.

By resistively impeding sound energy emitted from one face of the panel, interference between the sound energy emitted from front and rear faces of the panel may be reduced. Cancellation particularly at low frequencies, i.e. frequencies below 1 kHz, may therefore be reduced or controlled. Thus, the behaviour of the combination of panel and resistive structure more closely approaches a monopole source.

The panel may be resonant, e.g. of the general kind described in U.S. Pat. No. 6,332,029, and may be thus be capable of supporting resonant bending wave modes and modal energy. The resistive structure may interact with the modal energy in the panel and may thus wholly or partially damp the wave modes in the panel. The resistive structure may couple to the panel modes via a local air interface in the air gap. This may result in a more even spread of modes which may be particularly beneficial at the lowest frequencies where the distribution is more sparse.

The resistive structure must be acoustically porous and should not comprise any reactive content if a pure resistance is desired. Accordingly, the usual rubber-like and elastic soft foams are not suitable. The resistive structure may comprise layers of fabric with a graded weave, which may be held between two meshes or bonded to a rigid perforated plate. Alternatively, the resistive structure may be in the form of a plate. The plate may be made from a material selected from the group consisting of micro cellular foam, open cell foam, e.g. rigid phenolic or acrylic foam, porous micro tube structures such as those used for filtration, sintered metals, blown metals and ceramics.

By resistively impeding sound energy emitted from one face of the panel, the resistive structure may assist in reducing or controlling interference from any sound energy, particularly low frequency energy, which is reflected by a proximate surface or plane. Thus, the loudspeaker may be placed adjacent a coplanar boundary with the resistive structure sandwiched between the boundary and the panel.

Thus, the loudspeaker may be used as a ceiling loudspeaker for a modular ceiling assembly. The resistive structure may advantageously comprise a fire retardant component, for example, a non-flammable fabric supported in a mesh, or the structure may be made of open cell rigid foams. In contrast to known ceiling speakers, the sound directed into the ceiling plenum is controlled without the cost and weight of a back box, improving signal to noise ratio and helping in sound localisation techniques.

Alternatively, the loudspeaker may be used in an on-the-wall picture speaker. Hitherto, this type of speaker has used a back box to counteract the adverse effects of reflection and acoustic loading. Various reactive and resonant loading schemes have been devised in the past but achieving good lower frequency response has still proved difficult. The resistive structure addresses the rear reflection problem and provides a picture speaker with wide range reproduction and improved sound quality.

The effect of the resistive structure appears similar to that of a box baffle enclosing one face of the panel. However, in contrast to a box baffle, the resistive structure adds little additional depth and very little weight. Furthermore, the resistive structure does not stiffen the panel and hence the problem of raising the effective frequency modes of the panel is avoided.

According to another aspect of the invention, there is provided a combination comprising a bending wave acoustic panel which is capable of supporting bending wave vibration, the panel having a front face and a rear face which are both capable of radiating sound energy, and a resistive structure which is acoustically porous and which is mounted proximate to one face of the panel to resistively impede sound energy which is radiated from the face. This embodiment may be used as a passive acoustic assembly.

As described, both the passive acoustic assembly and loudspeaker may have monopole, unidirectional radiation properties down to low frequencies. Thus, improved bass performance may be achieved without the need for a box or enclosure and the unidirectional radiation may be a useful attribute for sound distribution.

### BRIEF DESCRIPTION OF THE DRAWING FIGURES

Embodiments that incorporate the best mode for carrying out the invention are described in detail below, purely by way of example, with reference to the accompanying drawing, in which:

FIG. 1 is a perspective view of a loudspeaker according to a first embodiment of the present invention;

FIG. 2 is a graph of the numerically modelled surface velocity against frequency for the loudspeaker of FIG. 1;

FIG. 3 is a graph of the numerically modelled acoustic pressure against frequency for the loudspeaker of FIG. 1;

FIG. 4a is a side elevational view of a loudspeaker similar to that of FIG. 4b, but without the resistive structure of the invention;

FIG. 4b is a side elevational view of a loudspeaker according to a second embodiment of the present invention;

FIGS. 5 and 6 are graphs of measured sound pressure level against frequency for the loudspeakers of FIGS. 4a and 4b, respectively;

FIG. 7 is a graph of measured sound pressure level against angle showing the directivity of the loudspeaker of FIG. 4a;

FIG. 8 is a graph of measured sound pressure level against angle showing the directivity of the loudspeaker of FIG. 4b;

FIGS. 9 and 10 are graphs of measured sound pressure level against angle for the loudspeaker of FIG. 4a;

FIGS. 11 and 12 are graphs of measured sound pressure level against angle for the loudspeaker of FIG. 4b;

FIG. 13 is a perspective view of part of a room having a wall mounted passive acoustic assembly according to the invention;

FIG. 14 is an exploded perspective view of a ceiling tile loudspeaker according to the invention;

FIG. 15 is a perspective view of part of a room having a wall mounted loudspeaker according to the invention; and

FIG. 16 is an exploded perspective view of the loudspeaker of FIG. 15.

It is to be understood that the invention is not limited in its application to the details of construction and the arrangement of components of preferred embodiments described below and illustrated in the drawing figures.

### DETAILED DESCRIPTION

FIG. 1 shows a loudspeaker comprising rectangular bending wave acoustic panel 10 which is capable of supporting bending wave vibration and which has a front face 12 and a rear face 14 which are both capable of radiating sound energy. The panel 10 is of length a, width b and depth h, and is mounted at its perimeter in a rigid baffle 16 which is also of depth h and which extends around the perimeter of the panel 10. The panel 10 is simply supported and is driven by an oscillating point force f provided by a vibration transducer 44.

An acoustically porous resistive structure 18 is mounted at a distance H from the rear face 14 of the panel. Thus an air gap 22 of height H is defined between the resistive structure 18 and the panel 10. The resistive structure 18 is of length La, width Lb and depth d, and is secured to a rigid base 20 of the same planar dimensions and negligible thickness.

The behaviour of the panel may be theoretically modelled by considering the panel as a thin plate whose transverse displacement w can be determined from:

$$D {∇}^{4} w + ρ \frac{{\partial }^{2} w}{\partial {t}^{2}} = 0 , \qquad ( 1 )$$

where ρ is the mass density of the plate material,

$$D = \frac{{Eh}^{3}}{12 ( 1 - {v}^{2} )}$$

is the plate stiffness, E is the Young's modulus, and ν is the Poisson ratio. The time dependence e−^{iωt} is assumed and suppressed throughout.

A common method for the solution of equation (1) is to use the normal modal decomposition in which the transverse response w of the plate may be expressed in terms of its mode shapes as

$$w = {\sum }_{i = 1}^{{n}_{s}} {φ}_{si} ( x , y ) {q}_{si} ( ω ) \qquad ( 2 )$$

where qₛᵢ is the response of the i-th structural mode. For a simply supported plate of the mass Mₚ in a rigid baffle the mass normalised mode shapes are given as

,φₛᵢ=(2/\sqrt{Mₚ})sin[(x+a/2−Lₐ/2)mᵢπ/a]sin[(y+b/2−L_{b}/2)nᵢπ/b] (3)

where mᵢ and nᵢ are the modal numbers for the i-th structural mode.

The acoustic pressure p_{f} on the surface of the resistive structure can also be presented in terms of the mode shapes as

$${p}_{f} ( x , y , ω ) = {\sum }_{i = 1}^{{n}_{f}} {φ}_{fi} ( x , y ) {q}_{fi} ( ω ) \qquad ( 4 )$$

where the normalized mode shapes are given by

φ_{fi}=(2c/\sqrt{LₐL_{b}H})sin(mᵢπx/Lₐ)sin(nᵢπy/L_{b}) (5)

and q_{fi} is the response of the layer to the i-th mode, and c is the sound speed in air.

The choice of the simply supported boundary conditions is convenient because it is possible to obtain a straightforward solution but is not restrictive. Similar results can be obtained for other types of boundary conditions by adopting the appropriate mode shapes φₛᵢ in equations (2) and (4). Using the boundary conditions on the surface of the plate and equations (1), (2) and (4), the velocity of the plate and the pressure in the air gap can be determined from the system of two-coupled matrix equations [6]

$$\{ \begin{matrix} ( - {ω}^{2} I + ⅈω D + {U}_{s}^{2} ) {q}_{s} + {S}^{T} {q}_{f} = f \\ {ρω}^{2} {Sq}_{s} + ( - {ω}^{2} I + ⅈω R + {U}_{f}^{2} ) {q}_{f} = 0\end{matrix} \qquad ( 6 )$$

where

$$S = {\int }_{( {L}_{a} - a ) / 2}^{( {L}_{a} + a ) / 2} {\int }_{( {L}_{b} - b ) / 2}^{( {L}_{b} + b ) / 2} {Φ}_{f}^{T} {Φ}_{s} ⅆ y ⅆ x$$

is the coupling matrix, Dᵤ=2ζᵢωₛᵢ is the diagonal structural damping matrix, U²ₛ_{ᵤ}=ω²ₛᵢ is the diagonal stiffness matrix and f=ƒΦₛ^{T}(xₗ,yₗ) is the forcing vector. The fluid damping caused by the absorbing layer is given by

$${R}_{ii} = Re \{ \frac{{c}^{2} {ρλ}_{{a}_{i}}}{H {ⅈωρ}_{a}} [ \frac{cos {λ}_{{a}_{i}} d + i ( {ρλ}_{{a}_{i}} / {ρ}_{a} {λ}_{i} ) sin {λ}_{{a}_{i}} d}{sin {λ}_{{a}_{i}} d - i ( {ρλ}_{{a}_{i}} / {ρ}_{a} {λ}_{i} ) cos {λ}_{{a}_{i}} d} ] \} \qquad ( 7 )$$

where λ²ₐᵢ=(ω/cₐ)²−(mᵢπ/Lₐ)²−(nᵢπ/L_{b})², λᵢ²=(ω/c)²−(mᵢπ/Lₐ)²−(nᵢπ/L_{b})², cₐ is the complex sound speed in the porous layer and ρₐ is the dynamic density of the effective fluid.

Finally, the fluid stiffness is given by

$${Ω}_{fii}^{2} = {ω}_{fi}^{2} - \frac{1}{ω} Im \{ \frac{{c}^{2} {ρλ}_{{a}_{i}}}{H {ⅈωρ}_{a}} [ \frac{cos {λ}_{{a}_{i}} d + i ( {ρλ}_{{a}_{i}} / {ρ}_{a} {λ}_{i} ) sin {λ}_{{a}_{i}} d}{sin {λ}_{{a}_{i}} d - i ( {ρλ}_{{a}_{i}} / {ρ}_{a} {λ}_{i} ) cos {λ}_{{a}_{i}} d} ] \} \qquad ( 8 )$$

Equation (6) can be solved directly for qₛ and q_{f}. The displacement w of the plate and the acoustic pressure p_{f} in the air gap can then be calculated from equations (2) and (4), respectively.

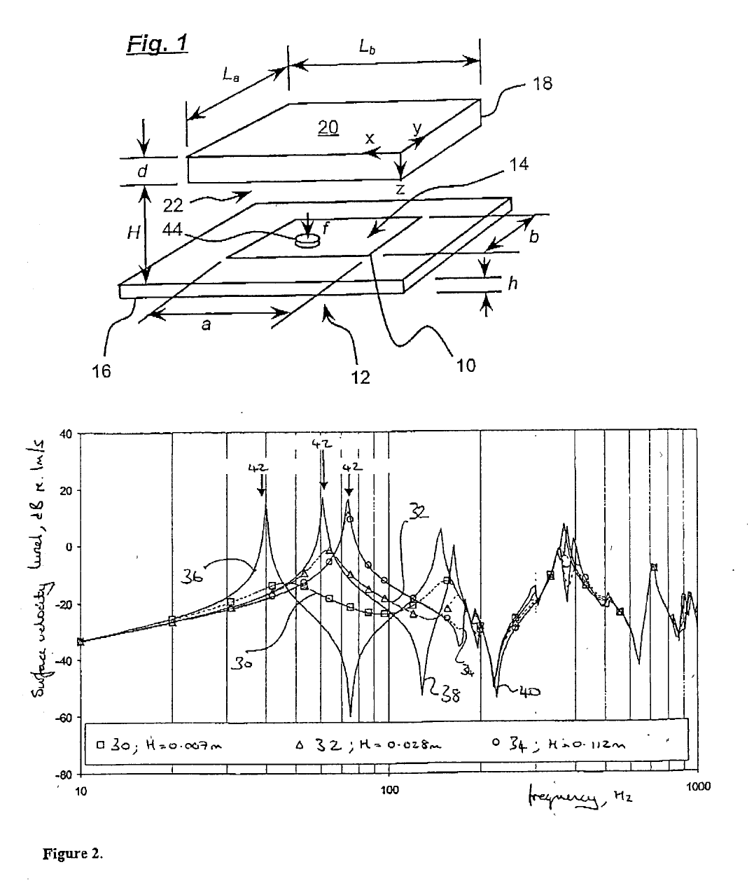

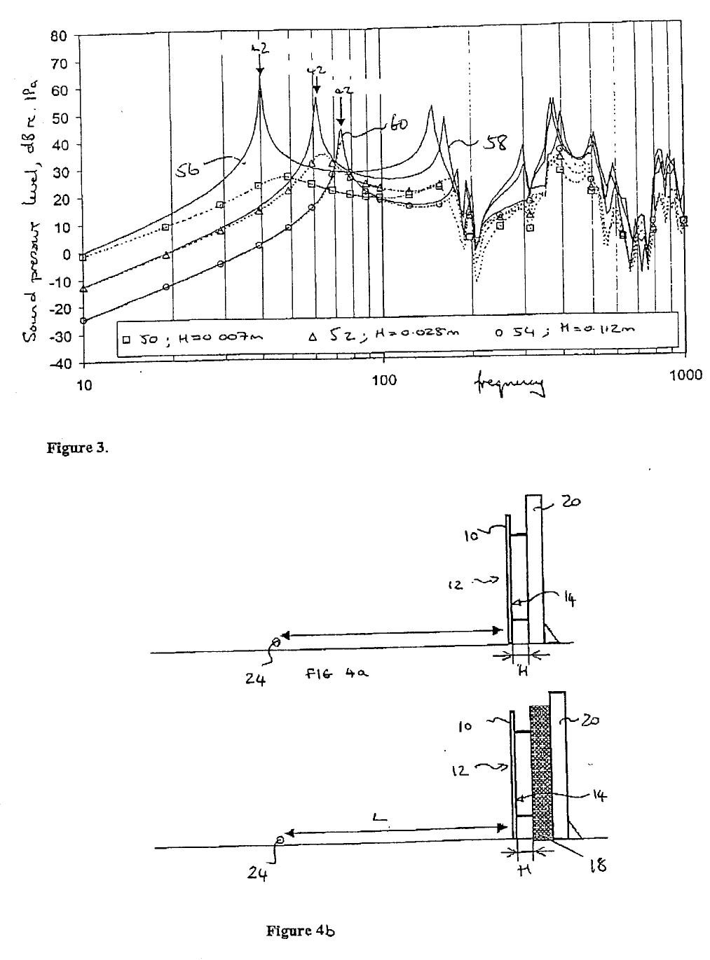

FIGS. 2 and 3 show the calculated results for the displacement w of the panel and the acoustic pressure p_{f} in the air gap for specific examples based on the embodiment shown in FIG. 1. In the specific examples, the panel is 6.5 mm thick and measures 415 mm by 367 mm, with a density of 100.62 kg/m³, a Young's modulus of 3.69×10⁸ N/m² and a Poisson ratio of 0.3. The panel is driven by a unit point force, which is applied simultaneously at two particular locations (0.155 mm, 0.185 m) and (0.205 m, 0.240 m).

The resistive structure is 25 mm thick melamine foam and measures 500 mm by 500 mm, with a flow resistivity R of 9800 Pa·s·m⁻². The properties of the resistive structure were modelled using cₐ=ω/kₐ and ρₐ=Zₐkₐ/ω. The rigid base also measures 500 mm by 500 mm and has an assumed flow resistivity of the order of 10⁷ Pa·s·m⁻². The air gap between the panel and the resistive structure is varied and is set at 7 mm, 28 mm and 112 m.

FIG. 2 shows the predicted surface velocity spectra in the centre of the panel for the three different widths of the air gap with and without the resistive structure. Three spectra 36,38,40 show the velocity for the different widths 7 mm, 28 mm and 112 m without the resistive structure respectively. Each of these spectra comprises clear resonances 42 which are associated with the structural modes of the simply supported, acoustically-loaded panel. The position of first and second structural resonances appears to be effected strongly by the width of the air gap. As the width of the air gap reduces, the resonance frequency decreases as a result of the increased acoustic loading of the panel. For this particular configuration it can be shown that any further increase of the width of the air gap beyond the value H=0.112 m results in a very little change of the velocity spectrum.

Three spectra 30,32,34 show the velocity for the different air gap widths 7 mm, 28 mm and 112 m with the resistive structure respectively. These spectra show that when the same panel is loaded with a resistive structure, a more uniform velocity spectrum may be achieved if the air gap is sufficiently small. In the case of larger air gaps the effect of the resistive structure is marginal. The amplitude of the surface velocity near the first two structural resonance frequencies is suppressed for air gap widths of 7 mm and 28 mm but not for an air gap of 112 mm. This suggests that an air gap of 112 mm is too large whereas an air gap in the range 7 to 28 mm may achieve the desired effect.

The damping in the panel increases as a result of the enhanced fluid-structure interaction between the vibrating panel and the resistive structure around the resonance peaks. The results suggest that in the presence of the resistive structure the resonance frequency shifts still occur, but when the width of the air gap is small the relative change is smaller than in the case of the rigid base. For example, the relative shift in the first resonance frequency between H=0.112 m and H=0.028 m is 46% when no resistive structure is present. This value is 38% when a 25 mm layer of melamine foam is attached to the rigid base.

FIG. 3 shows the sound pressure level spectra in the air gap for the three different widths of the air gap with and without the resistive structure. Three spectra 56,58,60 show the velocity for the different widths 7 mm, 28 mm and 112 m without the resistive structure respectively. As in FIG. 2, each of these spectra comprises clear resonances 42. The spectra 50,52,54 for the different widths 7 mm, 28 mm and 112 mm with the resistive structure, show that for air gaps of 7 mm and 28 mm, there appears to be a considerable suppression of these resonances. Accordingly, there is a more uniform sound pressure spectrum, which is often a desirable effect in audio engineering applications. As the width of the air gap increases, the effect of the porous layer becomes marginal and, in the case of the air gap of width 112 mm the sound pressure spectrum 54 follows closely the spectrum 60 without the resistive structure.

It is clearly important that the resistive structure is not mounted too close to the panel, since for an air gap of 7 mm there is also a considerable reduction of approximately 15 to 20 dB across the sound pressure spectrum. The resistive structure appears to be acting as an acoustic absorber and provides the medium to support the interfacial acoustic flow between parts of the planar radiator.

FIGS. 4a and 4b show a loudspeaker mounted near a rigid base 20 made from 25 mm thick, laminated MDF to ensure good acoustic reflection and low transmission characteristics. Each loudspeaker comprises a bending wave panel 10 which has parameters identical to that of the specific example used in FIG. 1. The panel 10 is not mounted in a baffle and has a front face 12 and a rear face 14 which are both capable of radiating sound energy.

In FIG. 4a, an air gap of width H is defined between the rear face 14 of the panel 10 and the rigid base 20. In FIG. 4b, an acoustically porous resistive structure 18 having parameters identical to that of the specific example used in FIG. 1 is mounted at a distance H from the rear face 14 of the panel. The resistive structure is thus mounted between the panel 10 and the rigid base. An air gap 22 of height H is defined between the resistive structure 18 and the panel 10.

A microphone 24 is set at a distance L from the loudspeaker to gather data which is processed by an MLS data acquisition and signal processing system. Both loudspeakers are set in a chamber having dimensions and signal to noise ratio which are sufficient to analyse the acoustic output from the loudspeakers in the frequency range 100 to 10000 Hz.

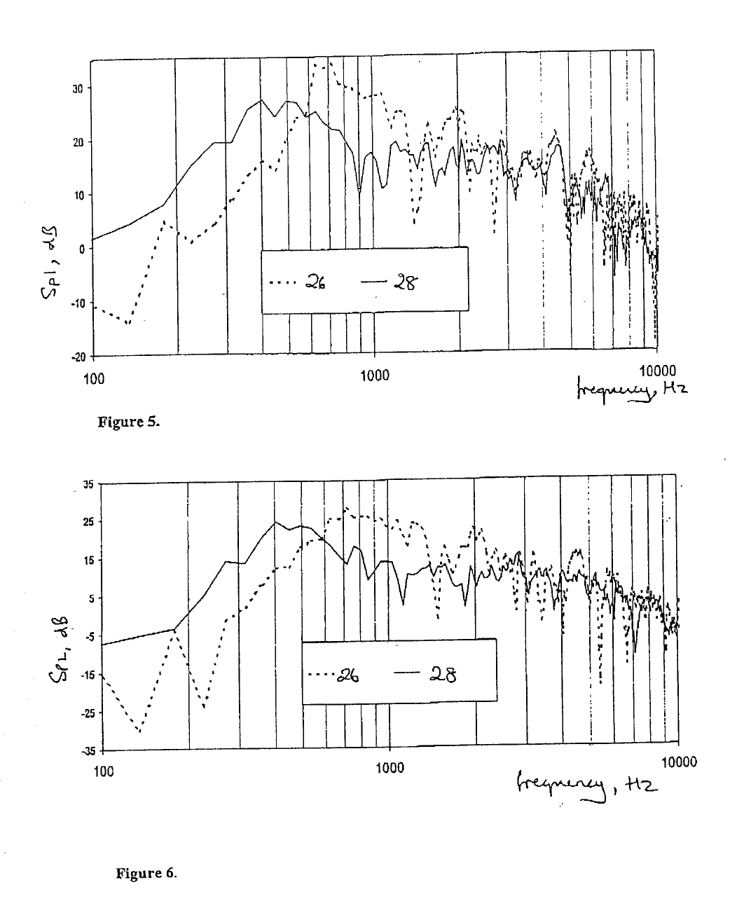

For FIGS. 5 to 8, the air gap H is set at 0.025 m. FIGS. 5 and 6 show the frequency responses 26, 28 for the loudspeakers of FIGS. 4a and 4b, respectively. The microphone is placed at a distance of 1 m and 2 m from the loudspeakers in FIGS. 5 and 6, respectively. As expected, the introduction of a resistive structure considerably affects acoustic emission from the loudspeaker and in particular the level of the fluctuations in the acoustic pressure spectrum is reduced. The acoustic output in the medium and high frequency range is reduced but at lower frequencies, below 500 Hz, the level of sound increases by up to 10 dB.

The fluctuations in acoustic pressure from the loudspeaker of FIG. 4a may result from the interference between the sound emitted by the opposite faces of the vibrating panel and the interference between the emitted and reflected sound energy. The resistive structure affects the amplitude and phase of the sound energy emitted from the rear face of the panel. Thus, interference maxima and minima associated with front and rear radiation may not develop fully in the far-field acoustic spectra. Furthermore, some individual resonances resulting from interference between emitted and reflected energy appear to be suppressed.

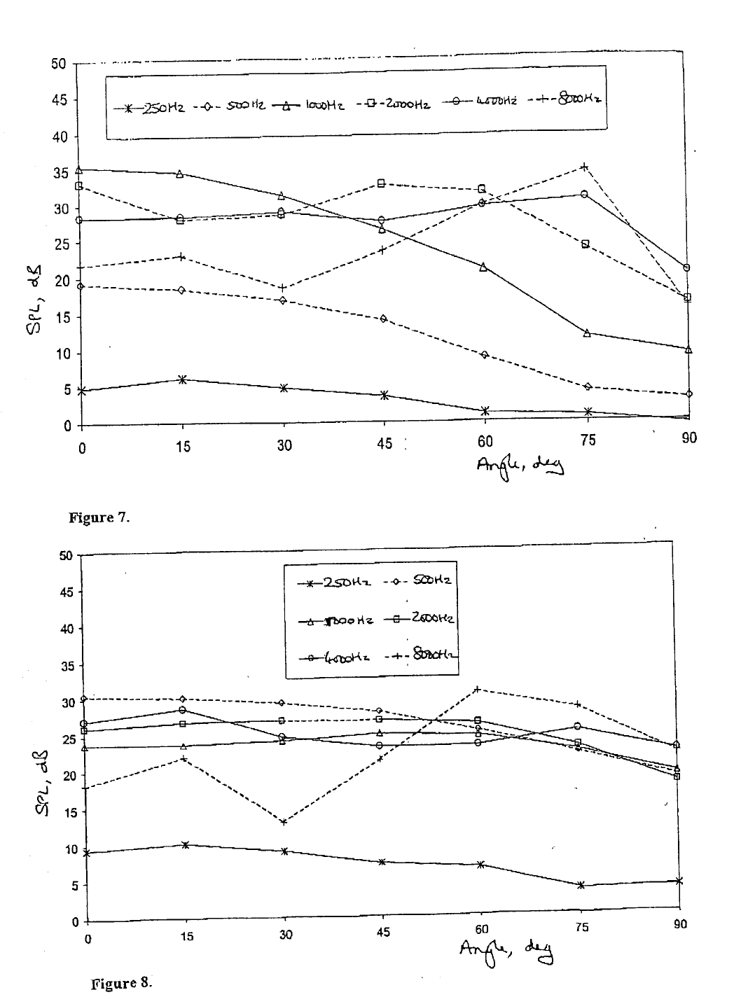

FIGS. 7 and 8 show the sound pressure level spectra measured at several horizontal angles between 0° and 90° from the normal to the panel for the loudspeakers of FIGS. 4a and 4b, respectively. The sound pressure is measured at the distance of 1 m. FIG. 8 shows that the addition of the resistive structure generally results in a more uniform directivity pattern of the acoustic emission. The level of fluctuations in the directivity pattern is reduced by approximately 10 to 15 dB.

At low frequencies, e.g. 500 Hz and 1000 Hz, the addition of the resistive structure reduces the roll-off in the levels of sound as the angle of incidence increases. Furthermore, at very low frequencies, i.e. 250 Hz, the addition of the resistive structure increases sound levels by 5-6 dB for all angles considered. Both of these improvements may be attributed to the elimination or reduction of the “acoustic shortcut” effect between the sound emitted by the opposite faces. In contrast, at very high frequencies, i.e. 8000 Hz, the addition of the resistive structure appears to have little effect on the acoustic emission. This may be explained by the relatively low coherence between the acoustic emission from different faces of the panel and reduced acoustic coupling between the resistive structure and the panel at such frequencies.

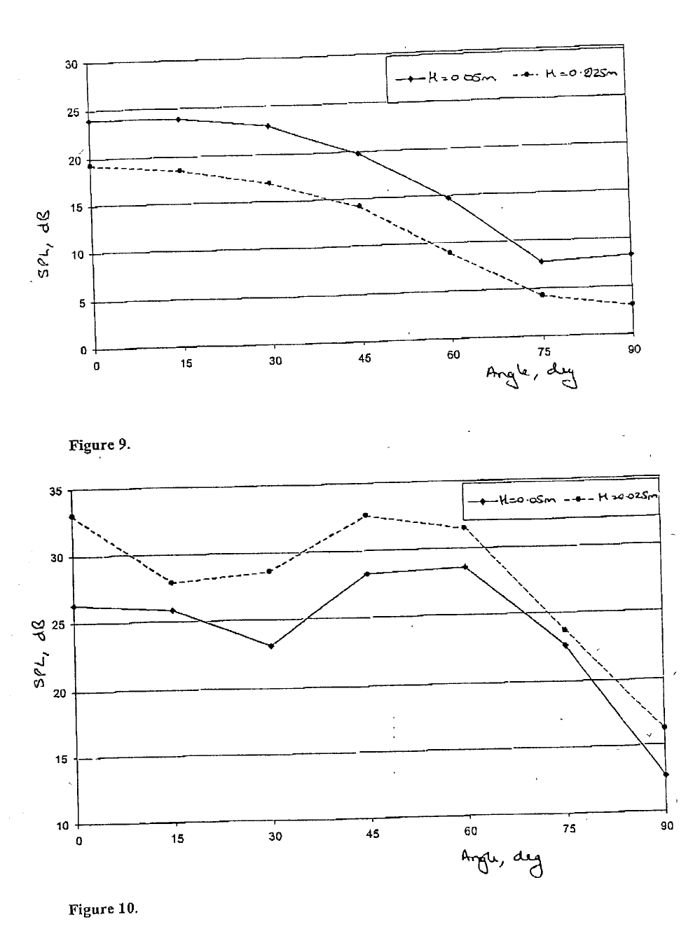

FIGS. 9 to 12 illustrate the effect of the width of the air gap on the sound pressure levels. The sound pressure is measured at the distance of 1 m. FIGS. 9 and 10 show sound pressure level spectra of the loudspeaker of FIG. 4a measured at several horizontal angles between 0° and 90° from the normal to the panel for frequencies of 500 Hz and 2000 Hz respectively. The spectra show a pronounced variation in directivity and the width of the air gap appears critical to performance. As shown in FIG. 9, at low frequencies, the acoustic output is increased if the width of the air gap is increased from 0.025 m to 0.05 m. In contrast as shown in FIG. 10, in the medium range of frequencies, increasing the air gap reduces the sound pressure level.

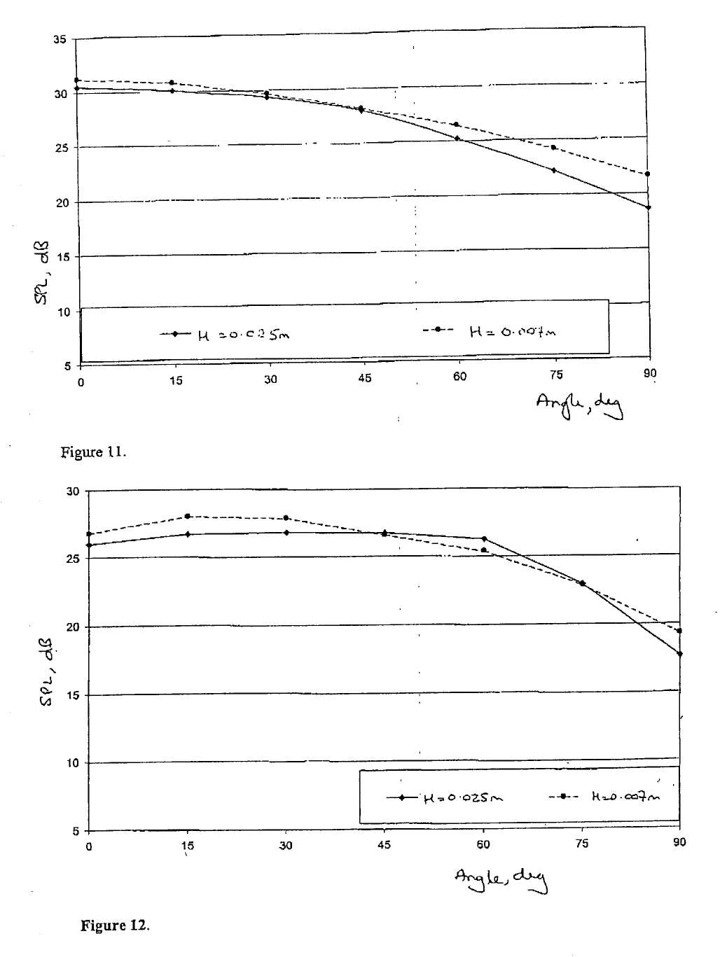

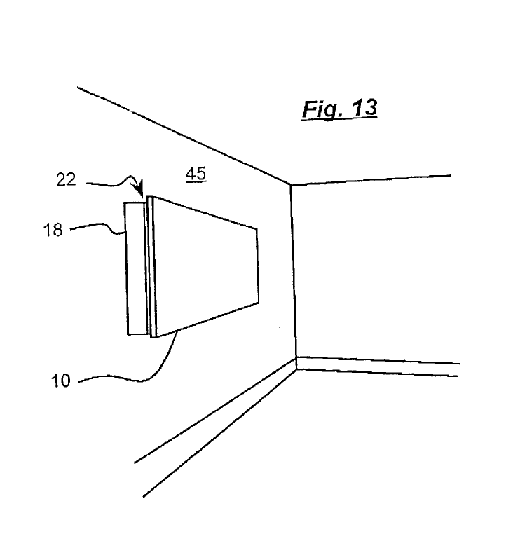

FIGS. 11 and 12 show sound pressure level spectra of the loudspeaker of FIG. 4b measured at several horizontal angles between 0° and 90° from the normal to the panel for frequencies of 500 Hz and 2000 Hz respectively. The introduction of the resistive structure results in a more stable output throughout the frequency range and in different directions of sound propagation, although there is still a small reduction of the sound pressure level as the angle of incidence increases. The effect of the width of the air gap on sound pressure levels is also small.

We have found that for panels of less than about 0.2 m square, an air gap in the range of about 0.5 mm to about 25 mm would be appropriate; for panels of between about 0.2 m and about 1.0 m square, an air gap in the range of about 1.0 mm to about 100 mm would be appropriate; and for panels greater than about 1.0 m square, the air gap may be up to about the square root of the panel area.

FIG. 13 shows one corner of a room with a passive bending wave acoustic panel assembly mounted on a wall 45, e.g. to condition the room acoustics. The panel assembly comprises a bending wave panel 10 mounted on a resistive structure 18 to define an air gap 22 therebetween, in the manner described above with reference to FIG. 1.

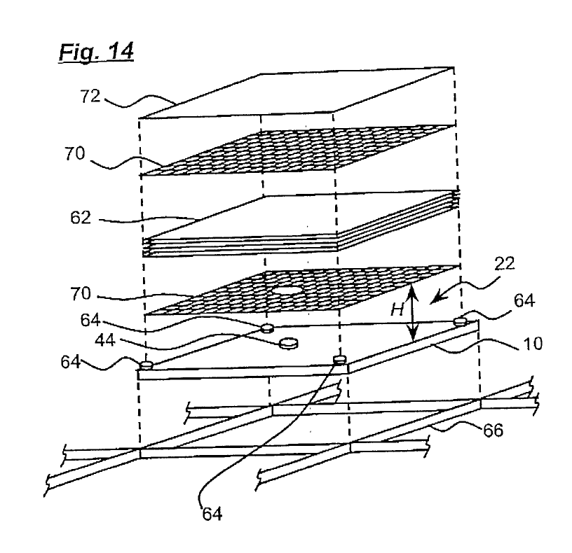

FIG. 14 is an exploded perspective view of a tile for a suspended ceiling of the kind supported on a ceiling frame structure 66, the ceiling tile comprising a loudspeaker of the kind described with reference to FIG. 1.

Thus the ceiling tile comprises a bending wave panel 10 and a resistive structure made from a stack of resistive fabric layers 62 sandwiched between acoustically porous mesh layers 70 and which is overlayed with a fire resistant layer 72. The resistive structure and the panel are spaced apart to form an air gap 22 therebetween by means of spacers 64 disposed at the respective corners of the panel.

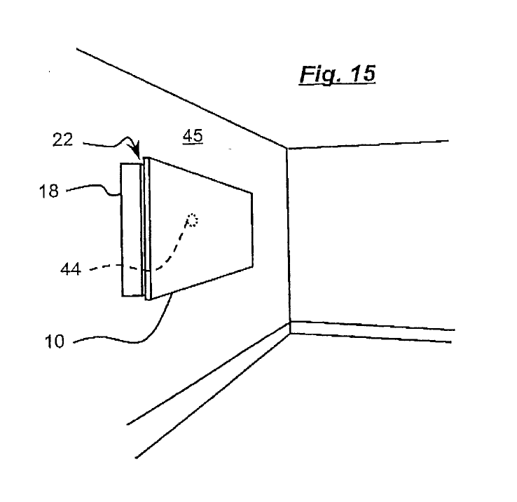

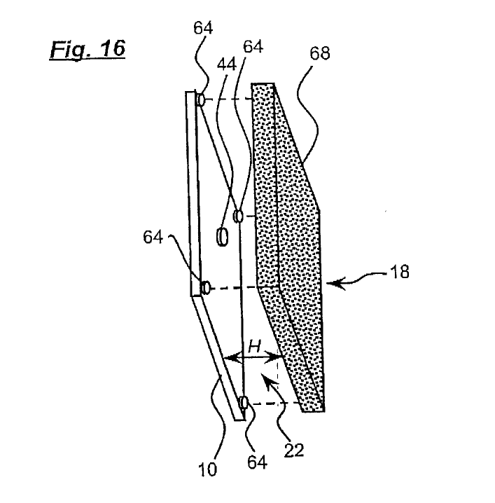

FIG. 15 shows a corner of a room with a panel-form loudspeaker of the kind described in FIG. 1 mounted on a wall 45. FIG. 16 is an exploded rear perspective view of the loudspeaker of FIG. 15, showing that the resistive structure 18 is in the form of a porous cellular structure, more particularly a melamine micro porous rigid foam. The resistive structure 18 is spaced from the panel 10 to form an air gap 22 by means of spacers 64 positioned at the corners of the panel 10.

In summary, mounting a resistive structure proximate to a panel provides additional damping and changes the acoustic flow of the sound energy from one face of the panel, whereby the following advantages may be achieved:

a) The amplitude of the resonance peaks in the surface velocity spectrum is reduced and the spectrum is more uniform.

b) The level of the sound pressure spectrum in the air gap is reduced and is more uniform near the frequencies of the structural resonance. Thus, interference between the acoustic output from the opposite faces of the panel is reduced and the emitted acoustic pressure spectrum measured in near- and far-field is more uniform.

c) The level of the fluctuations in the acoustic pressure spectra is reduced.

d) A more uniform directivity pattern is achieved.

e) Decreasing the width of the air gap has only a small effect on the acoustic output of the panel.

There may be some reduction of the acoustic output in the medium and higher frequency ranges, but an increase in the sound pressure level in the low frequency range.

In each embodiment, the panel may be as taught in U.S. Pat. No. 6,332,029 and other commonly owned patent specifications, and thus the properties of the panel-form member may be chosen to distribute the resonant bending wave modes substantially evenly in frequency. In other words, the properties or parameters, e.g. size, thickness, shape, material etc., of the panel-form member may be chosen to smooth peaks in the frequency response caused by “bunching” or clustering of the modes. In particular, the properties of the panel-form member may be chosen to distribute the lower frequency resonant bending wave modes substantially evenly in frequency. The resonant bending wave modes associated with each conceptual axis of the panel-form member may be arranged to be interleaved in frequency whereby a substantially even distribution may be achieved.

The transducer location may be chosen to couple substantially evenly to the resonant bending wave modes. In particular, the transducer location may be chosen to couple substantially evenly to lower frequency resonant bending wave modes. In other words, the transducer may be at a location where the number of vibrationally active resonance anti-nodes is relatively high and conversely the number of resonance nodes is relatively low.

It should be understood that this invention has been described by way of examples only and that a wide variety of modifications can be made without departing from the scope of the invention as described in the accompanying claims.

We claim:

1. A bending wave panel loudspeaker comprising:
a bending wave acoustic panel which is capable of supporting bending wave vibration, the panel having a front face and a rear face,
a transducer mounted to the panel to excite bending wave vibration in the panel in response to an electrical signal applied to the transducer so that sound energy is radiated from both the front and the rear faces of the panel, and
a resistive structure which is acoustically porous and which is mounted proximate to one face of the panel to resistively impede sound energy which is radiated from the face.

2. The loudspeaker of claim 1, wherein the bending wave acoustic panel is resonant and the transducer excites resonant bending wave modes in the panel, some of which are damped by the resistive structure.

3. The loudspeaker of claim 1 or claim 2, wherein the resistive structure is mounted so as to define an air gap between the rear face of the panel and the resistive structure.

4. The loudspeaker of claim 3, wherein the air gap is small enough to ensure useful resistive coupling between the sound energy radiated from the panel and the resistive structure.

5. The loudspeaker of claim 4, wherein the panel is less than about 0.2 m square, and the air gap is in the range of about 0.5 mm to about 25 mm.

6. The loudspeaker of claim 4, wherein the panel is in the range of about 0.2 m to about 1.0 m square, and the air gap is in the range of about 1.0 mm to about 100 mm.

7. The loudspeaker of claim 4, wherein the panel is greater than about 1.0 m square, and the air gap is up to about the square root of the panel area.

8. The loudspeaker of claim 3, wherein the resistive structure comprises a layer of woven textiles fabric.

9. The loudspeaker of claim 8, wherein the woven textiles fabric is sandwiched between layers of mesh.

10. The loudspeaker of claim 3, wherein the resistive structure is in the form of a plate.

11. The loudspeaker of claim 10, wherein the plate is made from a material selected from the group consisting of micro cellular foam, open cell foam, porous micro tube structures, sintered metals, blown metals and ceramics.

12. The loudspeaker of claim 10, wherein the plate is made from a microporous open cell rigid foam.

13. The loudspeaker of claim 12, wherein the micro porous open cell rigid foam is melamine.

14. The loudspeaker of claim 10, wherein the plate is mounted so that the plate is coplanar with the bending wave acoustic panel.

15. The loudspeaker of claim 3, in the form of a ceiling loudspeaker.

16. The loudspeaker of claim 15, wherein the resistive structure comprises a fire retardant component.

17. The loudspeaker of claim 3, in the form of an on-the-wall picture speaker.

18. The loudspeaker of claim 1, wherein the resistive structure comprises a layer of woven textiles fabric sandwiched between layers of mesh.

19. The loudspeaker of claim 1, wherein the resistive structure is in the form of a plate.

20. The loudspeaker of claim 19, wherein the plate is made from a material selected from the group consisting of micro cellular foam, open cell foam, porous micro tube structures, sintered metals, blown metals and ceramics.

21. A passive acoustic assembly comprising:
a bending wave acoustic panel which is capable of supporting bending wave vibration, the panel having a front face and a rear face which are both capable of radiating sound energy and
a resistive structure which is acoustically porous and which is mounted proximate to one face of the panel to resistively impede sound energy which is radiated from the face.

22. A passive acoustic assembly according to claim 21, wherein the resistive structure is mounted so as to define an air gap between the rear face of the panel and the resistive structure.
